(19) United States
(12) Patent Application Publication
(10) Pub. No.: US 2005/0229002 A1
(43) Pub. Date: Oct. 13, 2005

(54) System and method for sharing confidential semiconductor manufacturing information using transitory links

(75) Inventors: Cheng-Hui Chiu, Hsinchu City (TW); Ching-Chung Chang, Hsinchu City (TW); Feng-Kuang Sung, Hsinchu City (TW); Piao-Chuo Tsao, Bade City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co. Ltd., Hsin-Chu (TW)

(21) Appl. No.: 10/820,576

(22) Filed: Apr. 8, 2004

(51) Int. Cl. H04L 9/00

(52) U.S. Cl. 713/182

(57) ABSTRACT

The present disclosure provides a system for sharing confidential semiconductor manufacturing information which includes an access monitor module for authorizing user access to confidential information, an information sharing module for creating a transitory link to the confidential information in response to authorization, and a transitory link maintenance module for maintaining and removing the transitory link. A user may request access to the confidential information and, upon authorization, a transitory link is created which allows the user to access the confidential information. The transitory link is then removed from the system.

### BACKGROUND

The present disclosure relates generally to semiconductor manufacturing and, more particularly, to a system and method for sharing confidential semiconductor manufacturing information.

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed.

Furthermore, as the IC industry has matured, the various operations needed to produce an IC may be performed at different locations by a single company or by different companies that specialize in a particular area. This further increases the complexity of producing ICs, as companies and their customers may be separated not only geographically, but also by time zones, making effective communication more difficult. For example, a first company (e.g., an IC design house) may design a new IC, a second company (e.g., an IC foundry) may provide the processing facilities used to fabricate the design, and a third company may assemble and test the fabricated IC. A fourth company may handle the overall manufacturing of the IC, including coordination of the design, processing, assembly, and testing operations.

Communication may occur in various ways through a network. One such way is information sharing among several parties which can include customers, engineers, fabrication and design facilities, and many others. When information sharing includes confidential information, security concerns arise for both the semiconductor manufacturers and their customers. Technical information for a particular customer or group of customers may need to be accessed by authorized users, while it may be desirable for business information of particular customers to be kept from unauthorized users.

Accordingly, what is needed is a system and method for sharing confidential semiconductor manufacturing information that addresses the above-discussed issues.

### BRIEF DESCRIPTION OF THE DRAWINGS

FIG. 1 is a schematic view illustrating an embodiment of a virtual IC fabrication system.

FIG. 2 is a schematic view illustrating another embodiment of a virtual IC fabrication system.

FIG. 3 is a schematic view illustrating an embodiment of a computer system which may be used within a virtual IC fabrication system.

FIG. 4 is a schematic view illustrating an embodiment of a system for sharing confidential semiconductor manufacturing information.

FIG. 5 is a flowchart illustrating an embodiment of a method for sharing confidential semiconductor manufacturing information.

FIG. 6 is a schematic view illustrating an embodiment a system for using a transitory link to share confidential information.

FIG. 7 is a flowchart illustrating another embodiment of a method for sharing confidential semiconductor manufacturing information.

FIG. 8 is a flowchart illustrating a method for dynamically maintaining and removing a transitory link within a system for sharing confidential semiconductor manufacturing information.

### DETAILED DESCRIPTION

The present disclosure relates generally to semiconductor manufacturing and, more particularly, to a system and method for sharing confidential semiconductor manufacturing information using transitory links.

It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

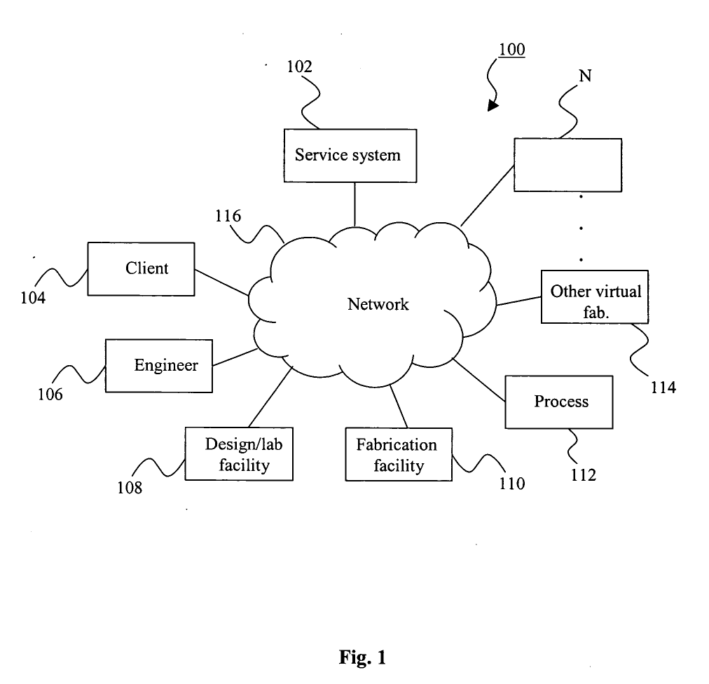

Referring now to FIG. 1, a virtual IC fabrication system (a “virtual fab”) 100, includes a plurality of entities 102, 104, 106, 108, 110, 112, 114, . . . , N that are connected by a communications network 116. The network 116 may be a single network or may be a variety of different networks, such as an intranet and the Internet, and may include both wireline and wireless communication channels.

In the present example, entity 102 represents a service system for service collaboration and provision, entity 104 represents a client, entity 106 represents an engineer, entity 108 represents a design/laboratory (lab) facility for IC design and testing, entity 110 represents a fabrication (fab) facility, entity 112 represents a process (e.g., an automated fabrication process), and entity 114 represents another virtual fab (e.g., a virtual fab belonging to a subsidiary or a business partner). Each entity may interact with other entities and may provide services to and/or receive services from the other entities.

For purposes of illustration, each entity 102-112 may be referred to as an internal entity (e.g., an engineer, client service personnel, an automated system process, a design or fabrication facility, etc.) that forms a portion of the virtual fab 100 or may be referred to as an external entity (e.g., a client) that interacts with the virtual fab 100. It is understood that the entities 102-112 may be concentrated at a single location or may be distributed, and that some entities may be incorporated into other entities. In addition, each entity 102-112 may be associated with system identification information that allows access to information within the system to be controlled based upon authority levels associated with each entities identification information.

The virtual fab 100 enables interaction among the entities 102-112 for the purpose of IC manufacturing, as well as the provision of services. In the present example, IC manufacturing includes receiving a client's IC order and the associated operations needed to produce the ordered ICs and send them to the customer, such as the design, fabrication, testing, and shipping of the ICs.

One of the services provided by the virtual fab 100 may enable collaboration and information access in such areas as design, engineering, and logistics. For example, in the design area, the client 104 may be given access to information and tools related to the design of their product via the service system 102. The tools may enable the client 104 to perform yield enhancement analyses, view layout information, and obtain other information. In the engineering area, the engineer 106 may collaborate with other engineers using fabrication information regarding pilot yield runs, risk analysis, quality, and reliability. The logistics area may provide the client 104 with fabrication status, testing results, order handling, and shipping dates. Client 104 could be customers, engineers, or related personnel from other manufacturing site or design house, or even the inside the manufacture. It is understood that these areas are exemplary, and that more or less information may be made available via the virtual fab 100 as desired.

Another service provided by the virtual fab 100 may integrate systems between facilities, such as between the design/lab facility 108 and the fab facility 110. Such integration enables facilities to coordinate their activities. For example, integrating the design/lab facility 108 and the fab facility 110 may enable design information to be incorporated more efficiently into the fabrication process, and may enable data from the fabrication process to be returned to the design/lab facility 108 for evaluation and incorporation into later versions of an IC. The process 112 may represent any process operating within the virtual fab 100.

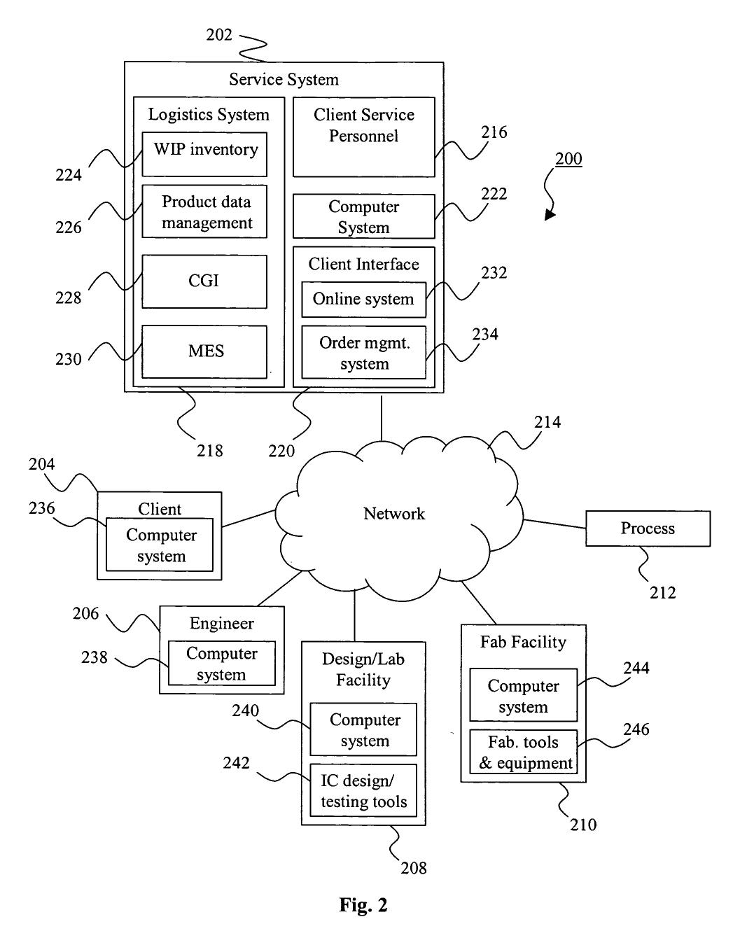

Referring now to FIG. 2, in another embodiment, a virtual fab 200 illustrates one possible implementation of the virtual fab 100 of FIG. 1. The virtual fab 200 includes a plurality of entities 202, 204, 206, 208, 210, and 212 that are connected by a communications network 214. In the present example, entity 202 represents a service system, entity 204 represents a client, entity 206 represents an engineer, entity 208 represents a design/lab facility for IC design and testing, entity 210 represents a fab facility, and entity 212 represents a process (e.g., an automated fabrication process). Each entity may interact with other entities and may provide services to and/or receive services from the other entities.

The service system 202 provides an interface between the client and the IC manufacturing operations. For example, the service system 202 may include client service personnel 216, a logistics system 218 for order handling, manufacturing tracking and information accessing, and a client interface 220 for enabling a client to directly access various aspects of an order.

The logistics system 218 may include a work-in-process (WIP) inventory system 224, a product data management system 226, a common gateway interface (CGI) 228, and a manufacturing execution system (MES) 230. The WIP inventory system 224 may track working lots using a database (not shown). The product data management system 226 may manage product data and maintain a product database (not shown). The product database could include product categories (e.g., part, part numbers, and associated information), as well as a set of process stages that are associated with each category of products. A CGI 228 is a standard interface for external applications with information servers such as Hyper Text Transfer Protocol (HTTP) or Web servers. Other options with the similar functions may include Active Server Page(s) (ASP) which is Microsoft web scripting language and file extension, or Java Server Pages (JSP).

The MES 230 may be an integrated computer system representing the methods and tools used to accomplish production. In the present example, the primary functions of the MES 230 may include collecting data in real time, organizing and storing the data in a centralized database, work order management, workstation management, process management, inventory tracking, and document control. The MES 230 may be connected to other systems both within the service system 202 and outside of the service system 202. Examples of the MES 230 include Promis, Workstream, Poseidon, and Mir1-MES. Each MES may have a different application area. For example, Mir1-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 230 may include such information as a process step sequence for each product.

The client interface 220 may include an online system 232 and an order management system 234. The online system 232 may function as an interface to communicate with the client 204, other systems within the service system 202, supporting databases (not shown), and other entities 206-212. The order management system 234 may manage client orders and may be associated with a supporting database (not shown) to maintain client information and associated order information.

Portions of the service system 202, such as the client interface 220, may be associated with a computer system 222 or may have their own computer systems. In some embodiments, the computer system 222 may include multiple computers, some of which may operate as servers to provide services to the client 204 or other entities. The service system 202 may also provide such services as identification validation and access control, both to prevent unauthorized users from accessing data and to ensure that an authorized client can access only their own data.

The client 204 may obtain information about the manufacturing of its ICs via the virtual fab 200 using a computer system 236. In the present example, the client 204 may access the various entities 202, 206-212 of the virtual fab 200 through the client interface 220 provided by the service system 202. However, in some situations, it may be desirable to enable the client 204 to access other entities without going through the client interface 220. For example, the client 204 may directly access the fab facility 210 to obtain fabrication related data.

The engineer 206 may collaborate in the IC manufacturing process with other entities of the virtual fab 200 using a computer system 238. The virtual fab 200 enables the engineer 206 to collaborate with other engineers and the design/lab facility 208 in IC design and testing, to monitor fabrication processes at the fab facility 210, and to obtain information regarding test runs, yields, etc. In some embodiments, the engineer 206 may communicate directly with the client 204 via the virtual fab 200 to address design issues and other concerns.

The design/lab facility 208 provides IC design and testing services that may be accessed by other entities via the virtual fab 200. The design/lab facility 208 may include a computer system 240 and various IC design and testing tools 242. The IC design and testing tools 242 may include both software and hardware.

The fab facility 210 enables the fabrication of ICs. Control of various aspects of the fabrication process, as well as data collected during the fabrication process, may be accessed via the virtual fab 200. The fab facility 210 may include a computer system 244 and various fabrication hardware and software tools and equipment 246. For example, the fab facility 210 may include an ion implantation tool, a chemical vapor deposition tool, a thermal oxidation tool, a sputtering tool, and various optical imaging systems, as well as the software needed to control these components.

The process 212 may represent any process or operation that occurs within the virtual fab 200. For example, the process 212 may be an order process that receives an IC order from the client 204 via the service system 202, a fabrication process that runs within the fab facility 210, a design process executed by the engineer 206 using the design/lab facility 208, or a communications protocol that facilities communications between the various entities 202-212.

It is understood that the entities 202-212 of the virtual fab 200, as well as their described interconnections, are for purposes of illustration only. For example, it is envisioned that more or fewer entities, both internal and external, may exist within the virtual fab 200, and that some entities may be incorporated into other entities or distributed. For example, the service system 202 may be distributed among the various entities 206-210.

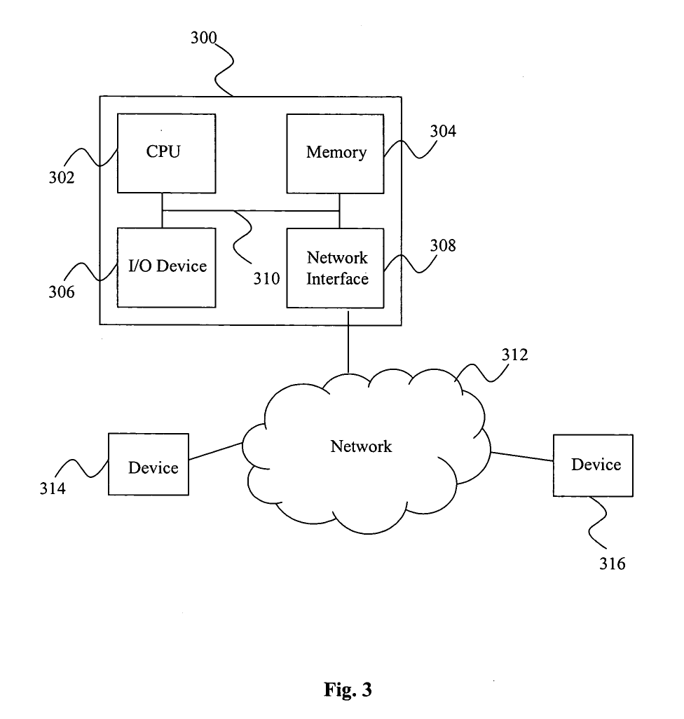

Referring now to FIG. 3, an exemplary computer 300, such as may be used within the virtual fab 100 of FIG. 1 or virtual fab 200 of FIG. 2, is illustrated. More particularly, computer system 300 can be used as computer systems 222, 236, 238, 240 and 244 of FIG. 2. The computer 300 may include a central processing unit (CPU) 302, a memory unit 304, an input/output (I/O) device 306, and a network interface 308. The network interface may be, for example, one or more network interface cards (NICs). The components 302, 304, 306, and 308 are interconnected by a bus system 310. It is understood that the computer may be differently configured and that each of the listed components may actually represent several different components. For example, the CPU 302 may actually represent a multi-processor or a distributed processing system; the memory unit 304 may include different levels of cache memory, main memory, hard disks, and remote storage locations; and the I/O device 306 may include monitors, printer, keyboards, and the like.

The computer 300 may be connected to a network 312, which may be connected to the networks 116 (FIG. 1) or 214 (FIG. 2). The network 312 may be, for example, a complete network or a subnet of a local area network (LAN), a company wide intranet, and/or the Internet. The computer 300 may be identified on the network 312 by an address or a combination of addresses, such as a media control access (MAC) address associated with the network interface 308 and an internet protocol (IP) address. Because the computer 300 may be connected to the network 312, certain components may, at times, be shared with other devices 314 and 316. Therefore, a wide range of flexibility is anticipated in the configuration of the computer. Furthermore, it is understood that, in some implementations, the computer 300 may act as a server to other devices 314, 316. The devices 314, 316 may be computers, personal digital assistants (PDA), wired or cellular telephones, or any other device able to communicate with the computer 300.

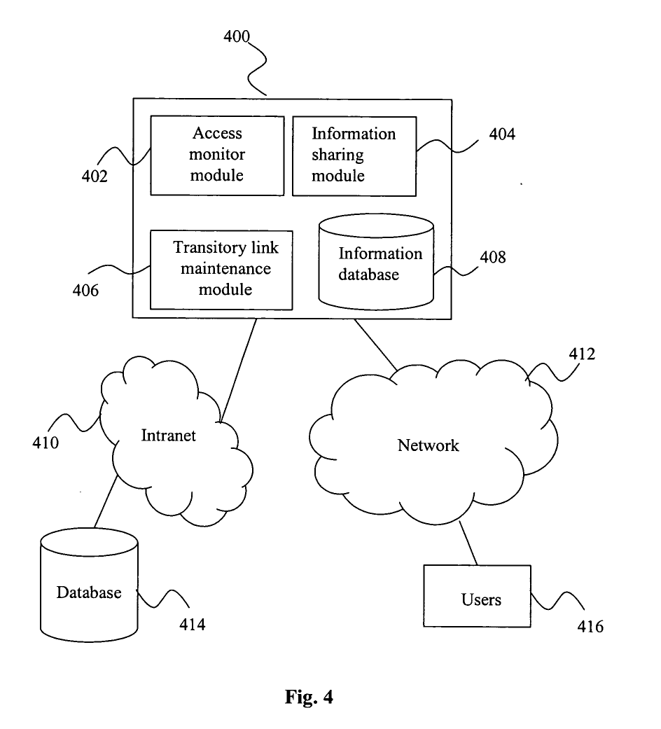

Referring now to FIG. 4, a schematic view illustrates an embodiment of a system for sharing confidential semiconductor manufacturing information 400. System 400 may be part of the virtual fab 100 of FIG. 1 or virtual fab 200 of FIG. 2 in order to allow the sharing of confidential information among a plurality of entities, any one of which may have access to all, some, or none of the information. System 400 includes an access monitor module 402, an information sharing module 404, and a transitory link maintenance module 406. The system may also include an information database 408, which may be a single database or a plurality of databases. The system 400 may be linked to an intranet 410 and a network 412. The intranet 410 is connected to a database 414, which may be a single database or a plurality of databases. Network 412 may be connected to a plurality of users 416.

The access monitor module 402 may be a set of codes or scripts which can be in any proper format or standard known in the art. In one embodiment, the access monitor module 402 may be written in the CGI. Functions of the access monitor module 402 may include checking user access authorization, monitoring user session activity and generally overseeing user access to the system.

The information sharing module 404 may provide the connection to allow for semiconductor manufacturing information access to users in the system. The information sharing module 404 may further include functional subsets such as information file matching, transitory link creation, and download mechanisms.

The transitory link maintenance module 406 may dynamically maintain transitory links in various ways including monitoring all created transitory links and link idle times, and removing transitory links which have either been used or remained idle for too long. A transitory link is a temporary link that is created to provide access to confidential information and is dynamically maintained and periodically removed from the system to ensure security of the confidential information that it has been linked to on the system. In one embodiment, all modules 402, 404, and 406 may be written in CGI, so the system for sharing confidential semiconductor manufacturing information 400 can be implemented in an unified format.

The information database 408 may include semiconductor manufacturing information that may be shared among users, and can encompass some or all of the available information used within the virtual fab 100 of FIG. 1 or virtual fab 200 of FIG. 2. This semiconductor manufacturing information may include business information, design and technology information, and manufacturing information. The business information may include information on customer profiles, purchase orders, shipping status, shipping notices, field application feedback, and customer support. The design and technology information may include information on technology files, design kits, semiconductor IP, library standard cells, reference flows, reticle field layout, and tape-outs. The manufacturing information may include information on works in process (WIP), online test data, statistical process control data, yields, and lot-hold status. Information may be confidential and only meant to be accessed by a specific user, or a particular group of users. This information may then be associated with a particular level of access. All databases may be located in multiple locations, stored in different formats and media, and connected to public network directly or indirectly such as through an intranet or storage area network (SAN). The information database 408 may be included into the system 400, or may be a plurality of independent databases which are updated, maintained and shared by many systems.

The system of sharing confidential semiconductor manufacturing information 400 is linked to the network 412. Users 416 are also linked to the network 412 as a infrastructure for semiconductor manufacturing information sharing, and may include plurality of users comprising customers, partners, vendors, and internal parties, the internal parties which may include those responsible for fabrication, design, marketing, sales, quality/reliability, and management.

The system of sharing confidential semiconductor manufacturing information 400 is also linked to an intranet 410. The intranet 410 may be connected to a database 414 which may include information such as user profiles and user privilege files in which a user's access to information in the system is defined.

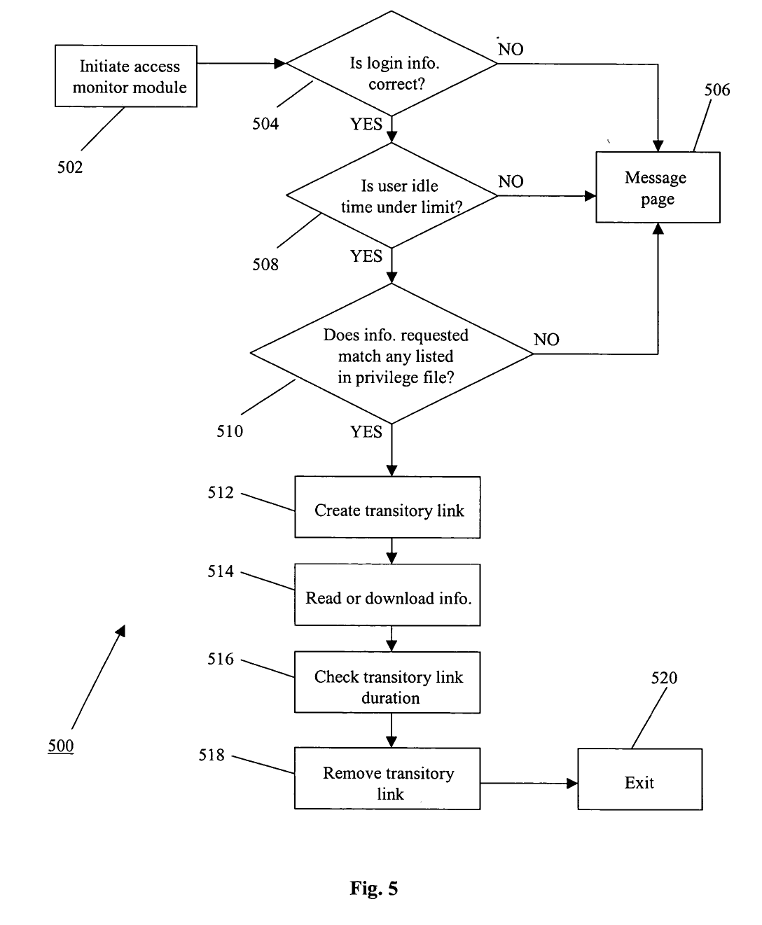

Referring now to FIG. 5, illustrated is a flow chart of one embodiment of a method of sharing confidential semiconductor manufacturing information 500. The method 500 may be implemented within a system such as the semiconductor manufacturing information sharing system 400 shown in FIG. 4, and is described with reference to system 400. At block 502, the user is has already attempted entry into system 400, either by logging in or some equivalent procedure prior to the execution of method 500.

Method 500 begins at block 502 by initiating the access monitor module 402, FIG. 4 and 5, which generally functions to oversee user access to the system.

At decision block 504, the access monitor module 402 will verify that the user has provided the correct login information. This can be accomplished a number of ways, such as through the use of cookies. A cookie includes data that a web server may store on a client system after a user has visited a web site. When a user returns to the previously visited web site, their browser sends a copy of the cookie back to the server. The cookie may be used to identify the user, instruct the server to send a customized version of the requested web page, submit account information for the user, and other administrative purposes. If the user has not logged in properly, the user will be directed to a message page at block 506. In this situation, message page at block 506 may be a page explaining that access has been denied due to a failed login attempt.

If the user has provided the correct login information, method 500 proceeds to decision block 508 where the access monitor module 402 will periodically check the user idle time, which is the span of time since the user last used system 400 since logon. If the user idle time exceeds a certain limit, the user will be directed to a message page at block 506. In this situation, message page at block 506 may be a page explaining that access is now denied due to the user session timing out because of inactivity. Parameters such as allowed user idle time may be set by the owner of system 400 and determined a number of ways, including predetermining the limit for all users, or dynamically changing the limit based on factors such as which user is accessing the system.

If the user idle time has not exceeded the limit, method 500 proceeds to decision block 510, where the information sharing module 404 will begin to process any information that has been requested. The information sharing module 404 will check the type of information the user has requested and the user privilege file in the users profile database. If the requested information does not match information listed in the user privilege file, the user will be directed to a message page at block 506. In this situation, message page at block 506 may be a page explaining that access is denied due to a lack of authorization to view the information requested. Further processing may follow.

The step of matching the information requested to information listed in the user privilege file works to protect confidential information from unauthorized sharing. As an example, when a user is approved in a request for information with a file path such as “http://www.microelectronic/database6.pdf”, then the user may guess another file with file path like “http://www.microelectronic/database5.pdf”. When such a file does exist, the user may be allowed access to the file even though they are not authorized to view the file. Decision block 510 solves this problem by requiring authorization for each confidential information file. The use of information matching with unified standards such as the CGI allows flexibility and customized operation for different download requests. For example, download processes may differ depending on the information file requested, requiring special efforts in order for users to download particular information files. Using information sharing module 404, the information file may be checked, and a special download sequence may be initiated according to that information file. The user then need only choose to download, and different download operations associated to each information file become transparent to the user.

If the requested information matches information listed in the user privilege file, method 500 proceeds to block 512, where a transitory link may be created.

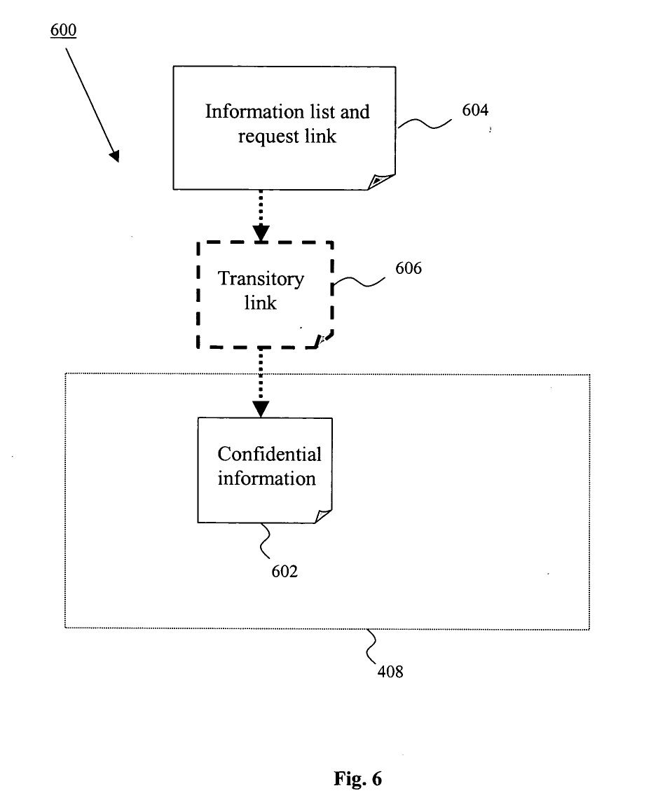

Referring now to FIG. 6, a schematic view illustrates an embodiment of a system for using a transitory link to share confidential information 600. Information database 408, FIG. 4 and FIG. 6, includes confidential information 602. Confidential information 602 may include semiconductor manufacturing information to be accessed by a user 416. An information list and request link 604 may exist disconnected from confidential information 602. In one embodiment, an information list and request link 604 may be a hyperlink. A hyperlink is a connection between an element in a hypertext document such as a word, phrase, symbol, or image, and a different element in the document or another document, file, or script. Information list and request link 604 may include a profile of the information available for the user to read and download. However, because information list and request link 604 is disconnected from confidential information 602, user 416 may not access confidential information 602. A transitory link 606 may be created to provide a connection between the information list and request link 604 and the confidential information 602 upon an authorized request for the confidential information 602. The transitory link 604 is a temporary link that will be dynamically maintained and, in one embodiment, may be a symbolic link.

A symbolic link, also referred to as soft link, is an indirect pointer to a file. It is a file that refers to another file by its pathname. In comparison, a hard link is essentially a label or name assigned to a file. In contrast to hard links, there are no restrictions on where a symbolic link can point, and it can refer to a file on another file system, to a directory, to itself or to a file which does not even exist (e.g. when the target of the symbolic link is removed).

Generally, a hard link (not shown) is connected to corresponding confidential information 320 with a information list and request link 604 pointed to the hard link, allowing a user to access a source file through the hard link which is on a web server and always there. When a transitory link 606 is used, there is no hard link between the information list and request link 604 and the confidential information 602, and without an authorized request from a user, no connection will exist between the information list and request link 604 and the confidential information 602. The system is secure in that a user cannot access confidential information 602 simply by guessing an information file pathname after logging into system 100 as there will be no connection or link to that information. The transitory link 606 may be created at block 512, FIG. 5, only after the user has provided the correct login information and the requested information has been matched to information in that users privilege file.

Referring back to FIG. 5, at block 514, the user may read or download information because the transitory link has been created. The user may perform any normal processing functions including opening a file, reading a file, downloading a file, saving a file, filling in fields on a file, and sending a file back to the database 408.

At block 516, the transitory link maintenance module 406 will conduct periodic scans of the system and check the link idle time, which is the amount of time any transitory links on the system have not been accessed. Parameters such as the allowed link idle time may be set by the owner of the system. The transitory link maintenance module 406 can be initiated in a number of ways, including by the information sharing module 404, on a predetermined schedule, or manually.

At block 518, the transitory link maintenance module 406 may remove any transitory links which have existed on the system for longer than the allowed link idle time. The allowed link idle time may be determined a number of ways, including setting a predetermined time, or dynamically selecting the time based on factors such as which user is accessing the file the link was created for, the confidentiality of the file the link was created for, and a number of other factors. Removal of the transitory links in this manner results in the links being dynamically maintained and cleaned off the system periodically. Risk of unauthorized accessing of files may be substantially eliminated due to the limited duration of the connection between the confidential information 602, FIG. 6, and the information list and request link 604.

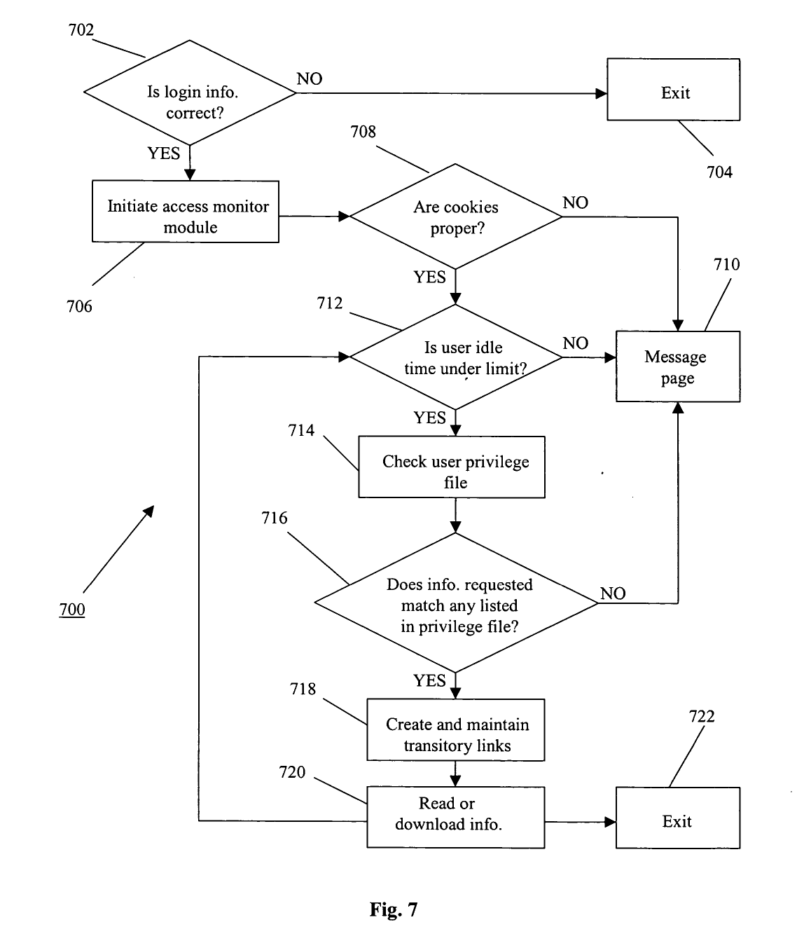

Referring now to FIG. 7, illustrated is a flow chart of another embodiment of a method of sharing confidential semiconductor manufacturing information 700. Method 700 may be implemented within a system such as the semiconductor manufacturing information sharing system 400 shown in FIG. 4, or within the virtual fabs 100 and 200 of FIG. 1 and 2, respectively, and is described with reference to them. All information requests may be handled by the CGI 228 of FIG. 2, or ASP, or JSP, or the like. The method 700 begins before a user logs into the semiconductor manufacturing information sharing system 400.

At decision block 702, a user provides login information to the semiconductor manufacturing information sharing system 400 by providing identification information such as a user ID and a password. The method 700 will check whether the provided login information is correct. If the login information is not correct, the system 400 will exit the user at block 704.

If the login information is correct, the method 700 will proceed to block 706, where the system of sharing confidential semiconductor manufacturing information 400 will initiate the access monitor module 402. Functions of the access monitor module 402 may include checking user access authorization, monitoring user session activity and generally overseeing user access to the system.

At decision block 708, the access monitor module 402 will check user cookies to verify that the user has logged in properly. A cookie includes data that a web server may store on a client system after a user has visited a web site. When a user returns to the previously visited web site, their browser sends a copy of the cookie back to the server. The cookie may be used to identify the user, instruct the server to send a customized version of the requested web page, submit account information for the user, and other administrative purposes. If the user's cookie is not approved, the user will be directed to a message page at block 710. In this situation, message page at block 506 may be a page explaining that access has been denied due to an improper login.

If the user's cookie is approved, the method 700 will proceed to decision block 712, where the access monitor module 402 will periodically check the user idle time, which is the span of time since the user last used system 400 since logon. If the user idle time exceeds a certain limit, the user will be directed to a message page at block 710. In this situation, message page at block 710 may be a page explaining that access is now denied due to the user session timing out because of inactivity. Parameters such as allowed user idle time may be set by the owner of system 400 and determined a number of ways, including predetermining the limit for all users, or dynamically changing the limit based on factors such as which user is accessing the system.

If the user idle time has not exceeded the limit, method 700 will proceed to block 714, where user privilege file will be checked if the user has requested confidential information. The access monitor module 402 will check what information the user has access to by checking the user privilege file stored in a database such as information database 408.

Method 700 will then proceed to decision block 716, where the information sharing module 404 will begin to process the requested confidential information. The information sharing module 404 will check the type of information the user requested, and compare that to what information the user has access to. If the requested information doesn't match information the user has access to, then the user will be directed to a message page at block 710. In this situation, message page at block 710 may be a page explaining that access is denied due to a lack of authorization to view the information requested. Further processing may follow.

If the requested information matches information that the user has access to, the method 700 proceeds to block 718, where a transitory link is created and maintained. Once created, this transitory link will connect the confidential information to an information list and request link similar to system 600 described in FIG. 6. After creation, the transitory link will be monitored to determine how long it has existed on the system and, if it has been on the system for longer than a certain time, it may be removed from the system, disconnecting the confidential information and the information list and request link.

Following the creation of the transitory link and before its removal, the method proceeds to block 720, where the user may read or download information through the transitory link. The user may perform any normal processing functions including opening a file, reading a file, downloading a file, saving a file, filling in fields on a file, and sending a file back to the database 408.

Once the user is done with the requested information, the user may exit system 400 at block 722, or may go back to decision block 712 to start another information request.

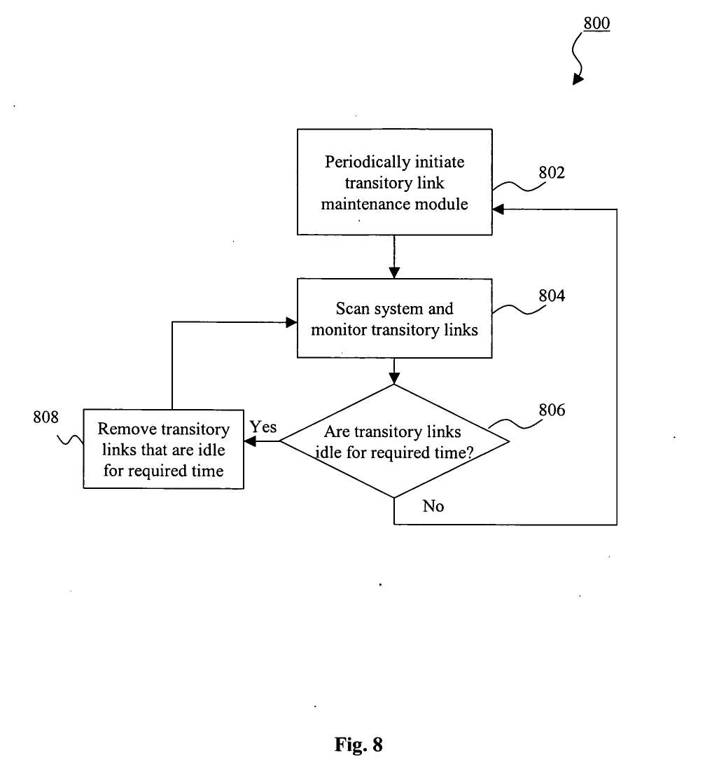

Referring now to FIG. 8, illustrated is a flow chart of an embodiment of a method of dynamically maintaining a transitory link 800. Method 800 may be implemented within a system such as the semiconductor manufacturing information sharing system 400 shown in FIG. 4.

The method 800 begins at block 802, in which the transitory link maintenance module 406 is periodically initiated. Initiation of the transitory link maintenance module may occur number of ways, such as at a predetermined times, manually, or by the information sharing module 404 after a user is finished with an information request.

Once the transitory link maintenance module has been initiated, method 800 proceeds to block 804, where the transitory link maintenance module 406 will scan the system for all accessed information and monitor the transitory link idle time, which is the amount of time any transitory links on the system have not been accessed.

Method 800 then proceeds to decision block 806, where the transitory link maintenance module determines whether any transitory links have existed on the system for longer than the allowed idle time. If no transitory links have exceeded the allowed idle time, the transitory maintenance module 406 returns to block 802 and waits to periodically be initiated for the scanning, monitoring, and removal of transitory links.

If transitory links have existed on the system longer than the allowed idle time, the transitory link maintenance module 406 will remove them. The allowed idle time may be determined a number of ways, including setting a predetermined time, or dynamically selecting the time based on factors such as which user is accessing the file for which the link was created, the confidentiality of the file for which the link was created, and a number of other factors. Thus, the transitory links are dynamically maintained and cleaned. Any risk of unauthorized accessing is substantially eliminated since a transitory link will no longer exist after an authorized request is processed and completed. Method 800 will then return back to block 804 to resume the scanning, monitoring, and removal of transitory links.

The present disclosure has been described relative to a preferred embodiment. Improvements or modifications that become apparent to persons of ordinary skill in the art only after reading this disclosure are deemed within the spirit and scope of the application. The present invention may be applied and implemented on a variety of manufacturing systems. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A system for sharing confidential semiconductor manufacturing information comprising:
an access monitor module for authorizing user access to confidential information;
an information sharing module for creating a transitory link to the confidential information in response to a user being authorized to access the confidential information; and
a transitory link maintenance module for maintaining the transitory link and removing the transitory link from the system.

2. The system of claim 1 wherein the access monitor module monitors user idle time and may grant access to the system upon verifying user authorization to access the system.

3. The system of claim 2 wherein the access monitor module denies user access to the system if the user idle time exceeds an allowable time limit.

4. The system of claim 1 wherein the information sharing module determines whether the confidential information is information the user is authorized to access and, in response to the confidential information being information the user is authorized to access, the information sharing module creating the transitory link.

5. The system of claim 1 further comprising:
a user privilege file, whereby the information sharing module may create the transitory link when the confidential information corresponds to information contained in the user privilege file.

6. The system of claim 1 wherein the access monitor module uses cookies to authorize access to the confidential information.

7. The system of claim 1 further comprising:
an information list and request link disconnected from the confidential information, whereby upon creation of the transitory link, the information list and request link is connected to the confidential information through the transitory link to allow for accessing of the confidential information.

8. The system of claim 1 wherein the transitory link maintenance module periodically monitors the system for the transitory link and a corresponding link idle time.

9. The system of claim 8 wherein the transitory link maintenance module removes the transitory link from the system if the corresponding link idle time exceeds an allowable time limit.

10. The system of claim 1 wherein the transitory link maintenance module removes the transitory link when the system indicates that the confidential information is no longer authorized to be accessed.

11. The system of claim 1 wherein the system exists within a virtual integrated circuit fabrication system.

12. The system of claim 1 further comprising:
a network coupled to the system.

13. The system of claim 1 further comprising:
a database coupled to the system.

14. The system of claim 1 wherein the access monitor module, the information sharing module, and the transitory link maintenance module are all written in the common gateway interface (CGI).

15. The system of claim 1 wherein the transitory link is a symbolic link.

16. A method for sharing confidential semiconductor manufacturing information comprising:
storing confidential information in a system;
receiving a request from a user for access to the confidential information;
authorizing the user to access to the confidential information in response to the user providing the correct authorization information;
creating a transitory link which allows the user to access to the confidential information; and
removing the transitory link.

17. The method of claim 16 wherein the authorizing may be performed when the user has a user idle time in the system that does not exceed an allowable time limit.

18. The method of claim 17 further comprising:
providing an information sharing module, wherein the authorizing may be performed in response to the user requesting confidential information that the information sharing module determines the user is authorized to access.

19. The method of claim 16 further comprising:
providing a user privilege file, whereby the authorizing may be performed when the confidential information corresponds to information contained in the user privilege file.

20. The method of claim 16 wherein the authorizing includes the use of cookies.

21. The method of claim 16 further comprising:
providing an information list and request link disconnected from the confidential information; and
connecting the information list and request link to the confidential information through the transitory link when the transitory link is created to allow the user to access the confidential information.

22. The method of claim 16 further comprising:
monitoring the system for the transitory link and the corresponding transitory link idle time, whereby the removing is performed when transitory link idle time exceeds an allowable limit.

23. The method of claim 12 wherein the removing is performed after the confidential information has been accessed through the transitory link.

24. The method of claim 12 wherein the system is a virtual integrated circuit fabrication system.

25. The method of claim 12 wherein the transitory link is a symbolic link.

26. A method for sharing confidential semiconductor manufacturing information comprising:
providing a virtual integrated circuit fabrication system;
coupling a database to the system;
storing confidential information in the database;
receiving a request from a user for access to the confidential information;
authorizing the user to access to the confidential information in response to the user providing the correct authorization information;
creating a transitory link which provides a connection to access the confidential information;
accessing the confidential information by the user through the transitory link; and
removing the transitory link.

27. The method of claim 26 wherein the authorizing may be performed in response to the user having a user idle time in the system that does not exceed an allowable limit.

28. The method of claim 27 further providing:
providing an information sharing module, wherein the authorizing may be performed in response to the user requesting confidential information that the information sharing module determines the user is authorized to access.

29. The method of claim 27 further comprising:
providing a user privilege file, whereby the authorizing may be performed when the confidential information corresponds to information contained in the user privilege file.

30. The method of claim 27 wherein the authorizing includes the use of cookies.

31. The method of claim 27 further comprising:
providing an information list and request link disconnected from the confidential information; and
connecting the information list and request link to the confidential information through the transitory link when the transitory link is created to provide a connection to the confidential information.

32. The method of claim 27 further comprising:
monitoring the system for the transitory link and the corresponding transitory link idle time, whereby the removing is performed when transitory link idle time exceeds an allowable limit.

33. The method of claim 27 wherein the removing is performed after the confidential information has been accessed through the transitory link.

34. The method of claim 27 wherein the transitory link is a symbolic link.
